(19) United States
(12) Patent Application Publication
(10) Pub. No.: US 2005/0043952 A1
(43) Pub. Date: Feb. 24, 2005

(54) System and method for enhancing performance of VoiceXML gateways

(76) Inventors: Ranjan Sharma, New Albany, OH (US); Danene A. Groenke, Apex, NC (US); Adolfo Lagomasino, Hyattsville, MD (US); Rob J. Surratt, Cary, NC (US)

Correspondence Address: Jones Day, 1155 Avenue of the Americas, New York City, NY, 10036-2711, US

(21) Appl. No.: 10/783,234

(22) Filed: Feb. 19, 2004

Related U.S. Application Data
(60) Provisional application No. 60/497,448, filed on Aug. 22, 2003.

(51) Int. Cl. G10L 11/00

(52) U.S. Cl. 704/270.1

(57) ABSTRACT

A system and method are disclosed for managing frequently used VoiceXML documents. In particular, a VoiceXML gateway is provided having an administrator-managed and provisioned local file system. Specifically, the administrator provisions the files that are to be stored on the local file system. Importantly, neither the VoiceXML interpreter nor the VoiceXML interpreter context manage the local file system. Accordingly, the local file system is not subject to the cache control directives that requires regular retransmission of frequently used VoiceXML documents and other files from the remote documents servers. To that end, administrator-provisioned files may be permanently stored on the local file system thereby minimizing their search and access time.

### CROSS REFERENCE TO RELATED APPLICATIONS

This application claims benefit under 35 U.S.C. § 119(e) of U.S. Provisional Application 60/497,448 filed on Aug. 22, 2003, which is incorporated herein by reference.

### FIELD OF THE INVENTION

The present invention relates generally to a method and system for providing voice-accessible Web content and services via VoiceXML, and in particular to improving performance of a VoiceXML gateway by using an administrator-provisioned local file system.

### BACKGROUND OF THE INVENTION

Driven by recent advances in speech recognition technology and growing demand for web-based services, the Internet industry has developed a Voice eXtensible Markup Language (VoiceXML)—a high-level computer language that is used to create voice-accessible Web content and services. See Voice Extensible Markup Language (VoiceXML) Version 2.0—W3C Candidate Recommendation 20 Feb. 2003, http://www.w3.org/TR/voicexml20 (last visited Oct. 1, 2003). VoiceXML is designed for creating audio dialogs that feature synthesized speech, digitized audio, recognition of spoken words and dual-tone multi-frequency (DTMF) key input, recording of spoken input, and mixed-initiative conversations. Its major goal is to bring the advantages of web-based development and content delivery to interactive voice response applications, especially those delivered by standard telephonic means, as HTML did for text and graphics applications. While HTML assumes a graphical web browser with display, keyboard, and mouse, VoiceXML assumes a voice browser with audio output, audio input, and keypad input. Audio input is handled by the voice browser's speech recognizer. Audio output consists both of recordings stored in audio files and speech synthesized by the voice browser's text-to-speech system in response to VoiceXML commands.

As FIG. 1 illustrates, VoiceXML applications are often implemented on specialized VoiceXML gateway hardware 110 that is connected both to the Internet and to the public switched telephone network (PSTN). A typical VoiceXML gateway can support hundreds to thousands of simultaneous audio dialogs with callers 101 and 102. Audio dialogs are specified in VoiceXML documents by textual commands that may refer to external audio files. Files referenced by VoiceXML dialog documents are typically provided to the gateway by one or more VoiceXML document servers 120, which may be standard web servers that store and retrieve web documents and maintain overall service logic, perform database and legacy system operations, and produce dialogs. The dialog documents are interpreted by VoiceXML gateway 110 in order to engage in dialogs with, e.g., callers 101 and 102.

In order to provide the natural, uninterrupted dialogs expected by callers, prompt access to dialog documents and audio files is most advantageous. Accordingly, VoiceXML gateways typically include caches managed by the VoiceXML interpreter in which recently retrieved documents and files are stored. These caches are usually managed in a manner similar to the caches of HTML browsers, namely the most recently retrieved files are automatically stored in the cache while the least recently used files are purged when necessary. Additionally, VoiceXML provides cache directives that permit documents being interpreted to issue explicit cache commands.

However, document caches, even when supplemented by explicit cache control directives, have been found to be insufficient to provide the necessary prompt and temporally predictable access to dialog documents. In particular, needed documents will often not be predictably found in the cache. This is a particular problem with VoiceXML where certain documents need to be predictably available and for long periods of time. If not predictably available, voice dialogs may have an objectionably erratic quality. Such documents include standard and frequently used announcements, top level VoiceXML root documents that provide the initial menu to a caller, and frequently used grammar files for speech recognition engines. When not in the cache, documents must be retrieved from the appropriate document server, a process which introduces often noticeable delays in the affected dialogs. Delays may arise even during normal network functioning, but are often acute at time of network or server congestion, as where a single server supports several gateways. Further, network or server outages may entirely disable dialog processing without warning.

Accordingly, unpredictable and often extended latencies during VoiceXML document retrieval is a problem in the prior art.

### SUMMARY OF THE INVENTION

An embodiment of the present invention overcomes the problems described above by providing a system and method that promptly, predictably, and reliably accesses dialog documents that are important for VoiceXML dialog processing. In particular, the system of the present invention includes a VoiceXML gateway having local file system for storing administrator-provisioned files. The method includes interpretation of voice dialog documents that explicitly and specifically reference one or more administrator-provisioned files stored in the local file system.

An embodiment of the present invention provides means for directly accessing VoiceXML documents instead of utilizing the known VoiceXML gateway caching mechanism. For example, dialog documents include syntactic modifications indicating that certain files are to be retrieved from a local file system. Alternately, a reserved portion of the file namespace may be set aside, and files with names in the reserved portion are indicated to be retrieved from the local file system. Importantly, the local file system is administrator-provisioned. This means that files in the local file system are selected, moved and stored in the local file system only under administrator command, and deleted from the local file system only in response to administrator command. The administrator is the person or entity responsible for the operation of the subject VoiceXML gateway. Automatic tools may be provided to assist the administrator in performing these actions. Notably, the local file system and its administrator-provisioned files are not subject to automatic cache control, either according to default (HTML-like) policies or in response to explicit cache control directives. These files are solely controlled by the administrator.

Further, when a particular file in the administrator-provisioned local file system is referenced by a dialog document, that particular referenced file is retrieved from the local file system. The administrator-provisioned files include those files that have particularly demanding (short) latency requirements, and may include VoiceXML documents, synthesized speech files, digitized audio files, grammar files, and the like. Files that are not indicated as being in the local file system are retrieved normally; for example, the file is retrieved from the cache if it is present there, and if not, it is requested through the cache by means of its URL address (a cache fault).

Although an embodiment of present invention is described in terms of interpreting VoiceXML documents (according to the current VoiceXML recommendation), it should be understood that the invention is not limited to such documents. It may also be applied to documents according to future VoiceXML recommendations and VoiceXML standards, and to documents according to other similar audio dialog languages, a language being similar if it permits documents to refer to external files.

In one embodiment, the present invention includes computer systems for processing system audio dialog documents having: a processor; a system cache coupled to the processor for temporarily storing files retrieved from a document server coupled to the computer system; a local file system coupled to the processor for permanently storing one or more administrator-provisioned files; and a program for causing the processor to interpret a VoiceXML document. When a VoiceXML document references an external file, if the external file is identified as being stored in the local file system, the program retrieves the external file from the local file system, and if the external file is not so identified, the program retrieves the external file from the system cache if resident therein, or, if not, from the document server and also stores it in the system cache after retrieval.

An external file is identified as being stored in the local file system if, for example, it is named in a distinctive manner, such as if its name comprises a file:// descriptor or a local:// descriptor, or is referred to by a special syntax or modified by a special parameter. The system cache is automatically managed by the processor in accordance with a cache control policy. The document server may be remotely located from the computer system. This embodiment also, though not necessarily, includes telephonic connections, such that the processor is capable of interpreting an audio dialog document and generating a voice output and recognizing voice input from a telephonically connected user.

One embodiment of the present invention is also a method of processing a VoiceXML document on a computer system, wherein the VoiceXML document references one or more administrator-provisioned files in a local file system coupled to the computer system. When a VoiceXML document references an external file, if the external file is indicated as being stored in the local file system, the method retrieves the external file from the local file system, and, if the external file is not so indicated, the method retrieves the external file from a system cache coupled to the computer system, if resident therein, or if not, from a document server coupled to the computer system and then also stores it in the system cache after retrieval, which is automatically managed by the processor in accordance with a cache control policy.

Another embodiment is a computer readable storage medium comprising computer executable code for causing a computer system to interpret a VoiceXML document, so that when the VoiceXML document references an external file, if the external file is determined to be an administrator-provisioned file stored in a local file system coupled to the computer system, the external file is retrieved from the local file system, and if the external file is determined not to be an administrator-provisioned file stored in a local file system, the external file is retrieved from a system cache coupled to the computer system, if resident therein, or if not, is retrieved from a document server coupled to the computer system and then also stored in the system cache after retrieval. The computer readable medium is used to distribute the code to, and to load the code onto, various computer systems, and may be part of a program product.

### BRIEF DESCRIPTION OF THE DRAWINGS

FIG. 1 is schematic diagram of a VoiceXML system architecture;

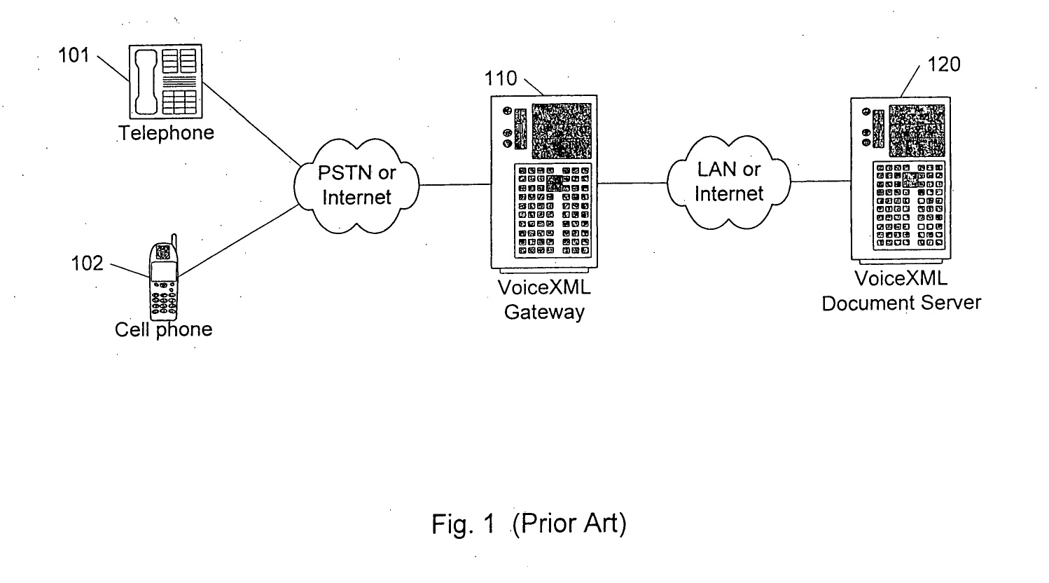

FIG. 2 is a block diagram of a VoiceXML gateway in one embodiment of the invention; and

FIG. 3 is a flow diagram of a method for processing VoiceXML documents in accordance with one embodiment of the invention.

### DETAILED DESCRIPTION OF THE INVENTION

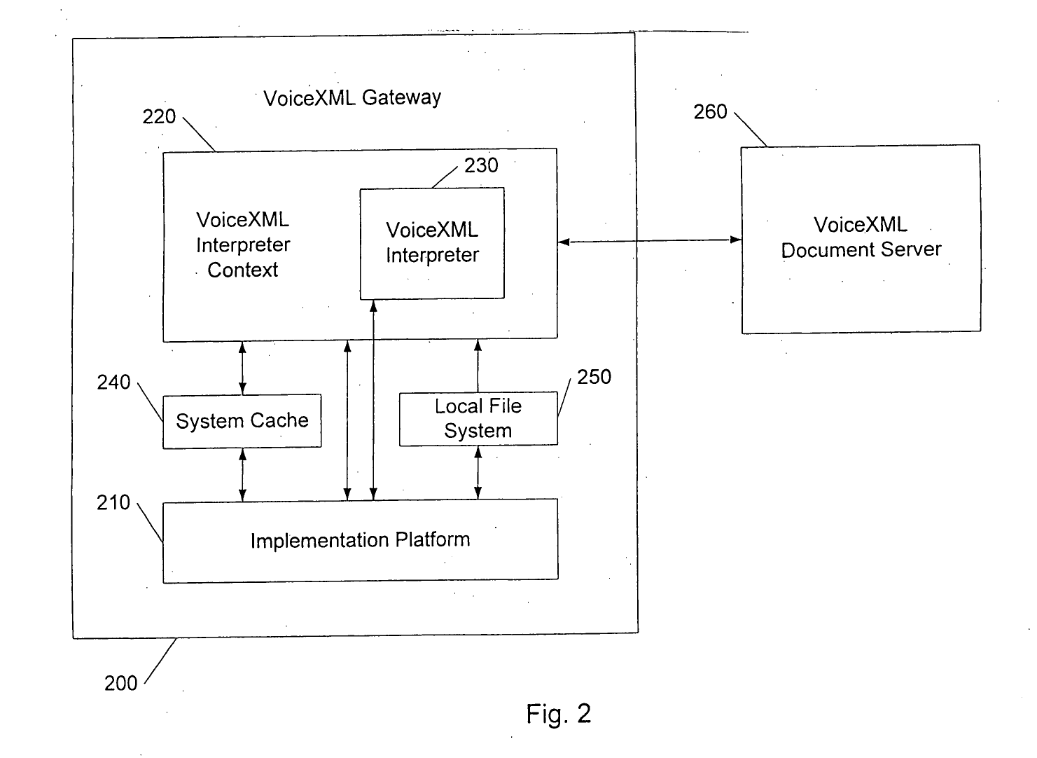

FIG. 2 illustrates a block diagram of a VoiceXML gateway in which an embodiment of the present invention may operate. VoiceXML gateway 200 comprises implementation platform 210, VoiceXML interpreter context 220, and VoiceXML interpreter 230. Implementation platform 210 is a computer system having voice generation and recognition capabilities to support voice dialogs with callers. VoiceXML interpreter context 220 is a software that controls implementation platform 210, as well as detects incoming calls, acquires initial VoiceXML documents, and answers the calls. VoiceXML interpreter 230 is a component of VoiceXML interpreter context 220 that operates in conjunction with implementation platform 210 to conduct voice dialogs with the callers by interpreting the VoiceXML documents.

VoiceXML gateway 200 also includes system cache 240 for storing recently retrieved VoiceXML documents and other files. System cache 240 is maintained and managed by VoiceXML interpreter context 220. The default caching policy for VoiceXML interpreter context 220 can be, for example, one commonly employed in HTML browsers: (1) if the document referenced by a Universal Resource Identifier (URI) is unexpired in the system cache 240, then use the cached copy; (2) however, if the referenced document is expired or not present in the system cache 240, then it is retrieved from document server 260 and stored in the system cache. Usually, storing a new document in the cache requires that an existing document (for example, the least recently used document) be purged. Also, even if the referenced document is in system cache 240 and is unexpired, VoiceXML interpreter context 220 must often periodically check whether a more recent version of the document is available from document server 260.

Certain types of VoiceXML documents are normally accessed by the VoiceXML interpreter context 220 frequently and over a long period of time. Retrieving such documents (and other documents) from a remote document server through an otherwise automatically managed system cache often leads to audio dialogs with noticeable and unacceptable latencies or to dialogs that fail to complete. Accordingly, this embodiment of the present invention provides an administrator-managed local file system 250 to enable access to locally maintained VoiceXML application resources. Local file system 250 is explicitly managed by the system administrator who provisions (by selecting and storing) files to be stored in the local file system 250. The administrator-provisioned files include frequently accessed and static VoiceXML files, such as synthesized speech files, digitized audio files, and telephony files. The present invention is not however limited to these types of files and any other type of file may be provisioned by the administrator to be stored in local file system 250.

In accordance with the described embodiment, local file system 250 resides on and is accessed through the implementation platform 210 of VoiceXML gateway 200. Local file system 250 may reside in the physical or virtual memory of implementation platform 210, provided that it is a nonvolatile type of memory. The administrator-provisioned files are permanently stored in the local file system 250 and are not removed from local file system 250 by either a hard or soft reset of VoiceXML gateway 200. In one embodiment, local file system 250 residing on hardware that is directly attached to the systems buses or similar internal interconnects of implementation platform 210. The file system hardware is highly reliable, and it may include one or more or magnetic discs, optical disks, or the like. The size of the disk allocated to local file system 250 is determined by the system administrator.

Local file system 250 is logically and physically separated from system cache 240, and therefore not subject to automatic cache control policies or explicit cache control commands. Also, the administrator has exclusive control over the provisioned files in local file system 250. By removing automatic cache control over the local file system 250, the administrator-provisioned files will not be automatically purged from local file system 250 or require retransmission from the remote document server 250. The administrator-provisioned files can be updated or removed altogether from the local file system 250 solely at the discretion of the system administrator.

In accordance with the described embodiment of the invention, neither VoiceXML interpreter context 220 nor VoiceXML interpreter 230 can write files into local file system 250. Administrator-provisioned files that are stored in local file system 250 can only be read by the VoiceXML interpreter context 220 or by VoiceXML interpreter 230 during document interpretation. In other words, from the point of view of audio dialog interpretation, the files in local file system 250 are read-only (static). Any other manipulations of the administrator-provisioned files are reserved to the system administrator. The system administrator may, at his discretion, assign additional control over local file system 250 to the VoiceXML interpreter context 220 and VoiceXML interpreter 230.

To distinguish VoiceXML interpreter requests for administrator-provisioned VoiceXML content from local file system 250 from system cache 240 requests and remote server requests, local file system 250 is accessed by a unique file system designator in an embodiment of the invention. The administrator-provisioned files may be referenced via a “file://” descriptor. Alternatively, a “local://” descriptor or other unique descriptor may be used, within the scope of the present invention, to distinguish local file system 250 from system cache 240 or remote document server 260. A portion of the file namespace is reserved and used only to designate files resident in the local file system. The local file system designator is valid for both initial and subsequent references within a VoiceXML document. To that end, the Dialed Number (DN)-to-URI mapping table data of the implementation platform 210 must recognize the local file system designator in the prefix of the URI field as a valid entry. Also, all references to files in local file system 250 are absolute, meaning they include a complete path name in reference to the fixed directory name designator for local file system directory.

In other embodiments, files stored in the local file system may be indicated by other methods known in the programming language arts. For example, a unique syntactic construction may be used, or a unique file access parameter may be designated, or the like, as long as local file system 250 is logically and physically separated from other file systems, system caches or any other type of permanent memory, random-access memory, or virtual memory maintained by implementation platform 210.

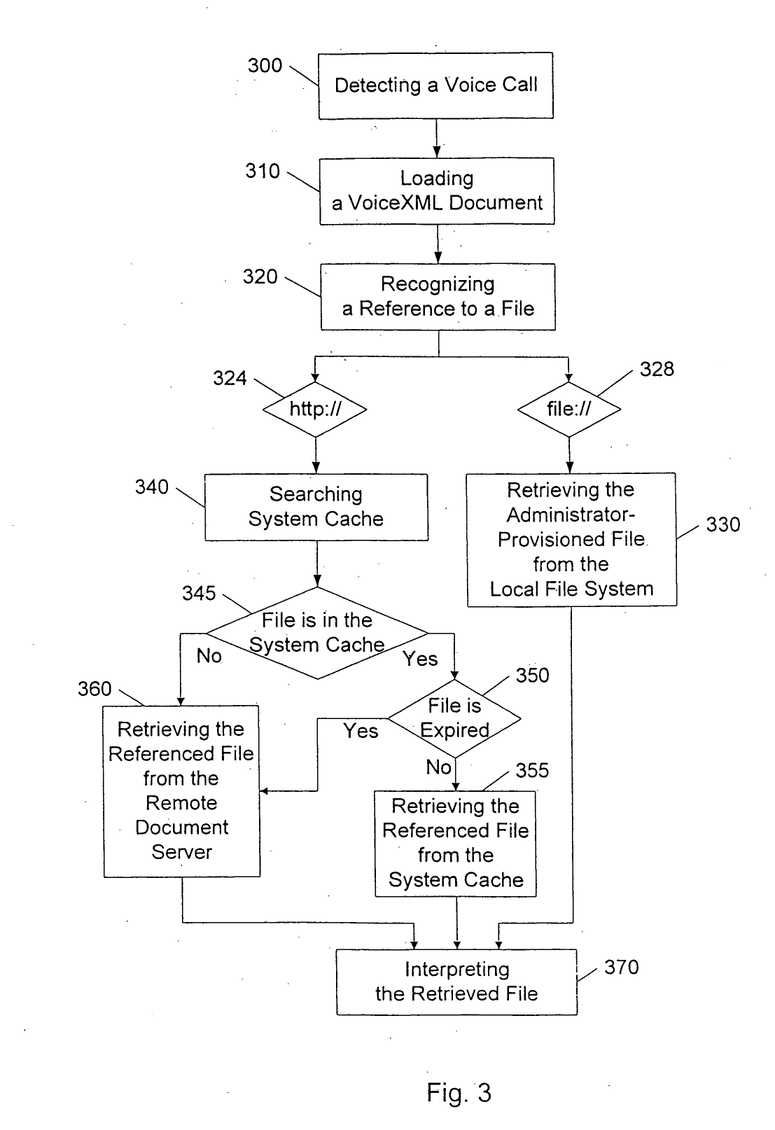

FIG. 3 schematically illustrates a flow diagram by which a system including a VoiceXML document interpreter may access, or may be modified to access, one or more files in the local file system according to the present invention. In step 300, a voice call from a user to a VoiceXML application is detected by VoiceXML gateway 200. In step 310, VoiceXML interpreter context 220 in conjunction with implementation platform 210 detects the incoming call, acquires the initial VoiceXML document, and invokes VoiceXML interpreter 230 to conduct an interaction dialog with the caller using or interpreting the initial VoiceXML document. The initial VoiceXML document is an administrator-provisioned file stored in local file system 250, because it does not change for a long period of time, is frequently accessed by the VoiceXML application, and requires short latency. Accordingly, the initial VoiceXML document is retrieved by the VoiceXML interpreter content 220 from local file system 250.

Next, the VoiceXML document is read and each time a reference to a file is recognized step 310 through 370 are performed. In step 320, a reference to a file is recognized in the body of the VoiceXML document. In an embodiment, if the file reference is identified by a “file://” designator (step 328) (or similar designator or syntactic construction), VoiceXML interpreter 240 recognizes the file to be administrator-provisioned and accordingly retrieves it from local file system 250, as shown in step 330.

However, if the file referenced is identified by a “http://” designator (step 324), or is otherwise designated as not being in the local file system, then in step 340, VoiceXML interpreter 240 retrieves the document in its normal fashion. First, in step 345, it searches system cache 240 for the referenced file. If the referenced file is found in system cache 240, VoiceXML interpreter context 220 checks file status in step 350; namely, whether it is not expired, whether it needs to be updated, or the like. If file is not expired and does not need to be updated, in step 355, the file is retrieved from system cache 240. If the referenced file is not in system cache 240, or the file is in the system cache but its status indicates that it is expired or needs to be updated, in step 360, the file is retrieved from remote document server 260, as directed by the URL address, which follows the http:// designator.

Next, in step 370, the referenced file, regardless of how it was retrieved, is interpreted by VoiceXML interpreter 330. Neither the VoiceXML interpreter 230 nor the VoiceXML interpreter context 220 manage local file system 250. Accordingly, unlike system cache 240, local file system 250 is not subject to the cache control directives that require regular retransmission of frequently used VoiceXML documents and other files from remote servers 260. Administrator-provisioned files, which are read-only to the dialog interpreter, may thus be permanently stored on local file system 250 thereby minimizing their search and access time.

In addition, the network/Internet access and associated latency to fetch remotely-stored files is eliminated altogether, being replaced by the much shorter latencies needed to access local disk storage (or other storage medium). Also, service disruption is prevented in the event that the remote document server hosting the application is down and cannot respond to a file request. Service disruption is minimized, or eliminated altogether, when a connection to the remote document server cannot be established. Call completion is guaranteed in cases where subsequent file retrievals were not possible due to any of the fetching and access-related issues. Additional overhead for retransmitting cached files either because they are expired or a more recent version may be available on a remote document server is avoided.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. For example, software components described above may also be implemented in hardware. Also, software and hardware components are not limited to the described computer system configuration or platform. Any suitable processor-based device or devices, for example, may be used.

A number of references are cited herein, the entire disclosures of which are incorporated herein, in their entirety, by reference for all purposes. Further, none of these references, regardless of how characterized above, is admitted as prior to the invention of the subject matter claimed herein.

1. A computer system for processing an audio dialog document having at least one reference to an external file, the computer system comprising:
a processor;
a system cache coupled to the processor for temporarily storing files retrieved from a document server coupled to the computer system; and
a local file system coupled to the processor for storing one or more administrator-provisioned files; and
wherein the processor reads the audio dialog document and, if at least one reference to the external file indicates that the file is stored in the local file system, retrieves the external file from the local file system.

2. The system of claim 1, where in the processor reads the audio dialog document and, if at least one reference to the external file does not indicate that the file is stored in the local file system, retrieves the external file from the system cache if resident therein, or if not, retrieves the external file from the document server, and stores it in the system cache after retrieval.

3. The system of claim 1, wherein an audio document comprises a VoiceXML document.

4. The system of claim 1, wherein all administrator-provisioned files are selected by a system administrator and stored in the local file system only by command of the system administrator.

5. The system of claim 1, wherein administrator-provisioned files are deleted from local file system only by command of the system administrator.

6. The system of claim 1, wherein the local file system consists essentially of administrator provisioned files.

7. The system of claim 1, wherein at least one administrator-provisioned file is an audio dialog document file, or a synthesized speech file, or a digitized audio file, or a grammar file.

8. The system of claim 1, wherein an external file is indicated to be stored in the local file system designated if it is named in a distinctive manner.

9. The system of claim 8, wherein a file is distinctively named if its name comprises a “file://” descriptor or a “local://” descriptor.

10. The system of claim 1, wherein the system cache is automatically managed by the processor in accordance with a cache control policy.

11. The system of claim 1 wherein the document server is remotely located from the computer system.

12. The system of claim 1, further comprising telephonic connections, and wherein interpreting an audio dialog document further comprises generating voice output to and recognizing voice input from a telephonically connected user.

13. A method of processing a VoiceXML document on a computer system comprising:
administrator-provisioning one or more files in a local file system coupled to the computer system; and
interpreting the VoiceXML document, wherein, when the VoiceXML document references an external file,
if the reference indicates that the external file is stored in the local file system, the external file is retrieved from the local file system, and
if the reference does not indicate that the external file is stored in the local file system, the external file is retrieved from a system cache coupled to the computer system, if resident therein, or if not, is retrieved from a document server coupled to the computer system and also stored in the system cache after retrieval.

14. The method of claim 13 wherein administrator-provisioning a file further comprises
selecting the file by a system administrator;
storing the selected file in the local file system by administrator command.

15. The method of claim 14 further comprising deleting a file from the local cache by administrator command.

16. The method of claim 13, wherein an external file is indicated to be stored in the local file system designated if it is named in a manner distinctive from files not so stored.

17. The method of claim 16, wherein a file is distinctively named if its name comprises a “file://” descriptor or a “local://” descriptor.

18. The method of claim 13, wherein the system cache is automatically managed by the processor in accordance with a cache control policy.

19. The method of claim 13 wherein the document server is remotely located from the VoiceXML gateway.

20. A computer readable storage medium comprising computer executable code for causing a computer system to interpret a VoiceXML document, so that when the VoiceXML document references an external file,
if the external file is determined to be an administrator-provisioned file stored in a local file system coupled to the computer system, the external file is retrieved from the local file system, and
if the external file is determined not to be an administrator-provisioned file stored in the local file system, the external file is retrieved from a system cache coupled to the computer system, if resident therein, or if not, is retrieved from a document server coupled to the computer system and also stored in the system cache after retrieval,
wherein an external file is determined to be an administrator-provisioned file stored in the local file system if the file is named in a manner distinctive from files not so stored.

21. The medium of claim 20 wherein the code further causes a computer system to:
to store in the local file system in response to a command from a system administrator a file previously selected by the system administrator; and
to delete from the local file system in response to a command from a system administrator a file previously selected by the system administrator.
